(19) United States
(12) Patent Application Publication
(10) Pub. No.: US 2005/0205196 A1
(43) Pub. Date: Sep. 22, 2005

(54) Multilayer substrate manufacturing method

(75) Inventors: Ayumi Nozaki, Tokyo (JP); Kiyoshi Saito, Tokyo (JP); Akira Yamada, Tokyo (JP); Shu Yamashita, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, TOKYO (JP)

(21) Appl. No.: 10/945,921

(22) Filed: Sep. 22, 2004

(30) Foreign Application Priority Data
Mar. 22, 2004 (JP) 2004-082412

(51) Int. Cl. C03B 29/00

(52) U.S. Cl. 156/89.11; 156/89.12

(57) ABSTRACT

A predetermined pattern of thick film, made of a material sintering-resistant at 1000° C. or lower, is screen printed on both surfaces of a green sheet to form constraint layers. The constraint layer has non-print regions in areas where via contacts are to be formed, where the constraint layer is removed in circles having a diameter of about 250 μm. Subsequently, via holes are formed in the green sheet and the contact holes are filled with a conductor paste by screen printing to form via contacts. Then a stack of such green sheets is pressed and integrated with a hydrostatic press device to obtain a green body. Next the green body is fired at lower temperature to obtain a low-temperature co-firable ceramic multilayer substrate.

### BACKGROUND OF THE INVENTION

1. Field of the Invention

The present invention relates to a method for manufacturing multilayer substrates, and particularly to a method for manufacturing a multilayer substrate using ceramic bonding for use in the formation of high-frequency circuits, microwave circuits and millimeter wave circuits.

2. Description of the Background Art

Low-temperature fired ceramic multilayer substrates are in practical use as techniques supporting high-level information communication. The low-temperature fired ceramic multilayer substrates are obtained by forming circuit patterns with a conductor paste on ceramic green sheets for low-temperature firing, stacking and integrating them and firing the stack, which are multilayer substrates that contain circuit interconnections built therein. They are called low-temperature co-firable ceramic multilayer substrates (hereinafter referred to simply as LTCC) since the ceramic and the conductor are fired simultaneously.

Low-temperature fired ceramic materials are generally mixtures of glass components and crystalline inorganic compounds, e.g. alumina, and the low-temperature means temperatures approximately at or below 1000° C.

The main factor of the sintering process of the low-temperature fired ceramic is the rapid densification caused as glass softens. Above the glass softening point, relatively large firing shrinkage rapidly occurs to approximately 75% in terms of the area ratio obtained by dividing the area of the sintered body in the plane where the circuit pattern is formed (or in the stacking plane, which is hereinafter referred to simply as plane) by the area of the green body.

Differences between the firing shrinkage behaviors of the green sheets and conductor paste cause substrate warping, circuit pattern distortion, and inferior conduction of via interconnects, so that the co-firable conductor paste must be chosen by considering the large rapid firing shrinkage of the green sheets.

The firing shrinkage is generally controlled, for example, by adjusting the particle size of metal particles of the conductor paste or by adding inorganic glass components to the conductor paste, but taking these measures alone is not sufficient. Another way to achieve this control is to suppress firing shrinkage difference during the firing process by, in the firing temperature pattern, rapidly elevating the temperature from the temperature at which the green sheet binder removal process ends to the temperature at which the ceramic substrate sinters and shortening the high temperature period.

However, the market is advancing to achieve further miniaturization and higher performance of information communication devices and so demanding higher density packaging of the low-temperature fired ceramic multilayer substrates, requiring techniques that enable stacking of an increased number of layers, formation of more via contacts, and more precise configuration of flip chip package pads.

Also, applications to microwave or millimeter wave frequency bands, in which resonators or filters are fabricated within the substrates, require formation of plane circuit patterns with higher configuration precision.

However, in reality, the current manufacturing techniques cannot satisfactorily meet these demands. That is to say, since the firing temperature pattern is formed of a rapid temperature elevating process and a short-time high-temperature keeping process, stacking an increased number of layers causes insufficient removal of voids that form as the ceramic structure is densified, which lowers substrate deflection strength and conductor adhesion strength. However, taking a countermeasure will lead to breakage of via interconnections and distortion of patterns due to the firing shrinkage or firing shrinkage differences mentioned above.

Japanese Patent Application Laid-Open No. 6-97656 (1994) (see FIG. 1: this reference is referred to as First Patent Document hereinafter) discloses a technique for reducing plane firing shrinkage, in which first green sheets sintering at 600° C. to 1000° C. and second green sheets sintering at 800° C. to 1500° C. are stacked and the stacked body is fired by a two-step temperature pattern, where the stacked body is first held at a first temperature at which the first green sheets sinter and then held at a second temperature at which the second green sheets sinter.

Japanese Patent Application Laid-Open No. 2000-25157 (see FIG. 1: this reference is referred to as Second Patent Document hereinafter) describes a method in which green sheets and films that contain sintering-resistant inorganic particles are stacked and the stacked body is fired to cause glass contained in the green sheets to penetrate into gaps among the sintering-resistant inorganic particles to achieve bonding.

Japanese Patent Application Laid-Open No. 2002-94244 (see FIG. 1: this reference is referred to as Third Patent Document hereinafter) describes a method in which base layers and constraint layers that contain sintering-resistant material with a small amount of glass previously added thereto are stacked to obtain strengthened adhesion between the green sheet layers by penetration of the glass of the constraint layers.

The methods of these three Patent Documents thus constrain the plane shrinkage of green sheets by using films of sintering-resistant material.

The method of First Patent Document requires that the first temperature be lower than the second temperature, which requires that the glass contained in the first green sheets be chosen so that it has a softening point lower than the second temperature.

A common technique for lowering the softening point of glass is the addition of alkaline metal, alkaline earth metal, which are glass modification elements. However, low-softening-point glass modified by this method tends to exhibit larger dielectric loss tangent than the original glass.

Therefore the high-frequency loss of the first green sheets is larger than that of the second green sheets and the multilayer substrate using these sheets exhibits larger high-frequency loss than when it is formed only of the second green sheets.

The methods of Second and Third Patent Documents require that the conductor pastes used as via contacts for interlayer interconnections and cooling of the packaged devices be chosen by considering firing shrinkage differences.

That is, in Second and Third Patent Documents, the plane shrinkage is restricted and the ceramic structure densification is limited to the green sheet stacking direction, and a firing shrinkage difference between the green sheets and the conductor paste filling via contacts causes the via contacts to project out, which causes local distortion of the conductor pattern in the vicinities of the via contacts and may cause cracking in the vicinities of via contacts passing through a plurality of layers.

Also, considering that the low-temperature fired ceramic multilayer substrates are mainly applied to high-frequency circuits and microwave circuits and that they are now applied also to millimeter wave circuits with higher-density packaging, it is desirable to develop manufacturing techniques that enable formation of an increased number of via contacts per unit area and develop substrate materials with low dielectric loss tangent.

From these viewpoints, it is difficult to produce higher industrial values than conventional ones by applying the techniques of First to Third Patent Documents to high-density package low-temperature fired ceramic multilayer substrates used for high-frequency circuit, microwave circuit and millimeter wave circuit applications.

### SUMMARY OF THE INVENTION

In the manufacture of low-temperature co-firable ceramic multilayer substrates for high-density packaging that are applied to high-frequency circuits, microwave circuits and millimeter wave circuits, an object of the present invention is to provide a multilayer substrate manufacturing method which offers reduced loss in high-frequency or higher bands and which is capable of reducing via disconnection caused by firing and preventing projection of via contacts.

A multilayer substrate manufacturing method according to a first aspect of the present invention includes the steps of (a) preparing a plurality of green sheets and (b) stacking and integrating the green sheets to form a green body. The step (a) includes the steps of (a-1) printing, on the green sheet, constraint layers for restricting firing shrinkage which have a predetermined pattern, (a-2) forming via holes in the green sheet on which the constraint layers are formed, and (a-3) forming predetermined circuit patterns on the green sheets with a conductor paste and filling the via holes with the conductor paste to form via contacts. The step (a-1) includes the step of forming the predetermined pattern in areas where the via holes are to be formed in the green sheets so that non-print regions exist around the via holes and the step of forming the constraint layers on both main surfaces of the green sheet except those placed as the uppermost and lowermost layers of the green body.

According to this multilayer substrate manufacturing method, the constraint layer is formed so that non-print regions having a larger area than the via holes exist in positions where the via holes are to be formed in the green sheet, so that the constraint layer is absent around the via contacts formed by filling the via holes with a conductor. This nearly matches the firing shrinkage behaviors of the via contacts and the surrounding green sheet area and prevents projection of the via contacts. Also, the constraint layers are formed on both surfaces of the green sheets except those placed as the uppermost and lowermost layers of the green body. When conductor patterns are formed on the green sheets, this prevents warping of the conductor patterns.

A multilayer substrate manufacturing method according to a second aspect of the present invention includes the steps of (a) preparing a plurality of green sheets and (b) stacking and integrating the green sheets to form a green body. The step (a) includes the steps of (a-1) printing constraint layers for restricting firing shrinkage on, at least, the green sheets that are located in the uppermost and lowermost layers of the green body, (a-2) forming via holes in the green sheets on which the constraint layers are formed, and (a-3) forming given circuit patterns on the green sheets with a conductor paste and filling the via holes with the conductor paste to form via contacts. The step (a-1) includes the step of preparing the green sheets so that one or more of the green sheets, except the green sheets located in the uppermost and lowermost layers of the green body, have no constraint layer and the step (b) includes the step of stacking the green sheet or sheets having no constraint layer in a middle of the green body.

According to this multilayer substrate manufacturing method, the green sheets are prepared so that one or more of the green sheets except those placed in the uppermost and lowermost layers of the green body have no constraint layer and the green sheet or sheets having no constraint layer are stacked in the middle of the green body. This reduces the plane shrinkage restricting effect and prevents projection of via contacts.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view illustrating a via interconnection formed within a green body;

FIG. 2 is a cross-sectional view illustrating projection of via contacts;

FIGS. 3A to 3G are cross-sectional views illustrating the process steps for manufacturing a multilayer substrate according to the preferred embodiment of the invention;

FIG. 4 is a plan view showing an example of a constraint layer pattern;

FIG. 5 is a plan view showing an example of a constraint layer pattern;

FIG. 6 is a plan view illustrating the plane structure of a green sheet;

FIG. 7 is a plan view illustrating an example of conductor pattern;

FIG. 8 is a diagram illustrating the structure of a jig used to stack layers;

FIG. 9 is a cross-sectional view illustrating shifting of the axis of an via interconnection in the green body; and

FIG. 10 is a diagram showing the relation between an area ratio and the standard deviation of the shift of the via interconnection axis.

### DESCRIPTION OF THE PREFERRED EMBODIMENTS

<Technical Idea of the Invention>

Before describing the preferred embodiment, the technical idea of the present invention is now discussed.

Common LTCC green sheets are glass-alumina based and the main factor of the sintering process is the rapid densification caused as glass softens. Above the glass softening point, relatively large firing shrinkage rapidly occurs, which amounts to approximately 75% in terms of the area ratio obtained by dividing the area of the sintered body in the plane where the circuit pattern is formed (or in the stacking plane, which is hereinafter referred to simply as plane) by the area of the green body. Therefore the co-firable conductor paste is chosen by considering the large rapid firing shrinkage of the green sheets.

For the purpose of matching the firing shrinkage behaviors of the green sheets and the conductor pastes, measures are applied to materials, e.g. by adjusting the particle size of metal particles in the conductor pastes, choosing organic components of vehicles, adjusting their composition ratios, adding glass frit components, and so on. At the same time, optimum firing temperature patterns are experimentally obtained and reflected to manufacturing conditions.

The inventors, too, tried to achieve adjustments of components of conductor pastes and firing temperature patterns, which, however, failed to find satisfactory improvements. We therefore made the consideration below to find other measures for improvements.

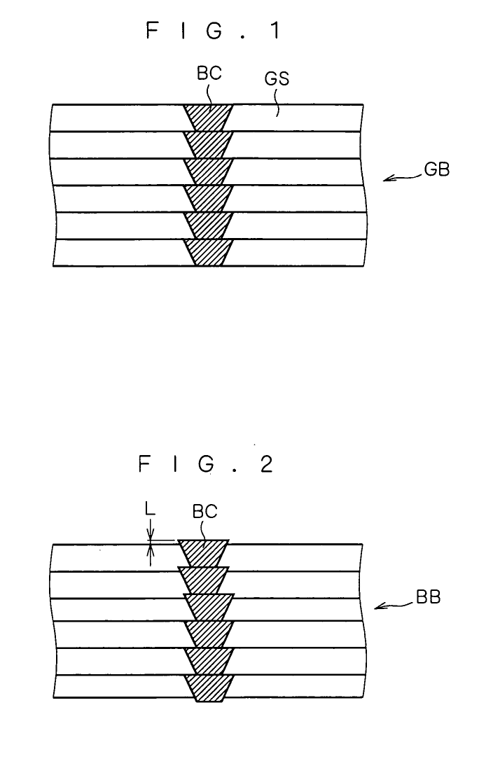

First, as shown in FIG. 1, suppose a green body GB is formed of a stack of a plurality of LTCC green sheets GS each having a via contact BC. Individual via contacts BC are filled with a conductor paste and are located in the same position of the LTCC green sheets GS. When the LTCC green sheets GS are thus stacked on top of each other, the via contacts BC are connected in the stacking direction to form a via interconnection.

When the shrinkage of the green sheets GS within the stacking plane is not restricted, then the firing shrinkage behaviors of the green sheets GS and the conductor paste cannot be perfectly matched. If the shrinkage of the green sheets GS is somewhat larger, then, as shown in FIG. 2, the via contacts BC, after fired, would project from the main surface of the fired body BB (ceramic). The amount of projection from the main surface of the fired body BB is represented as L.

From a simple viewpoint, the fired body BB portion separated from the via contacts BC shrinks according to the shrinkage rate of the green sheets GB and the via contacts BC shrink according to the shrinkage rate of the conductor paste. Therefore the amount of projection, L, of the via contacts BC reflects the firing shrinkage difference between the green sheets GS and the conductor paste.

For example, let us suppose that the green body GB shrinks approximately isotropically except at the boundaries between the fired body BB and the via contacts BC and that it shrinks after fired to 87% in each direction and the conductor paste shrinks to 89% in each direction. Then, the amount of projection of the via contacts BC with respect to the main surface portion of the fired body BB in a position separated from the via contacts BC is ½ of the shrinkage difference, which corresponds to about 1% of the substrate thickness.

However, if the green body GB does not shrink within the stacking plane, the shrinkage due to densification is limited to the stacking direction. Then, if the volume of the sintered body is the same as that of the isotropic case, then the shrinkage in the stacking direction is about 66% with the green body GB and about 70% with the conductor paste.

Under this condition, the amount of projection L of the via contacts BC is about 2% of the substrate thickness, which is about two times larger than when the green body GB isotropically shrinks.

That is to say, when the amount of projection of the via contacts BC is the main consideration, it is required, when the shrinkage in the stacking plane is restricted, that the firing shrinkage behavior of the co-firable conductor paste be matched with that of the green sheets to a higher degree than in conventional cases. However, the inventors and the like know from experience that it is extremely difficult to obtain conductor paste exhibiting such firing shrinkage behavior.

Accordingly, on the basis of the above-mentioned consideration that restricting the shrinkage in the stacking plane enlarges the projection of via contacts, we reached the technical idea of this invention that the projection of via contacts can be suppressed by controlling the effect of restricting the shrinkage in the stacking plane.

<Preferred Embodiment>

<A. Manufacture Method>

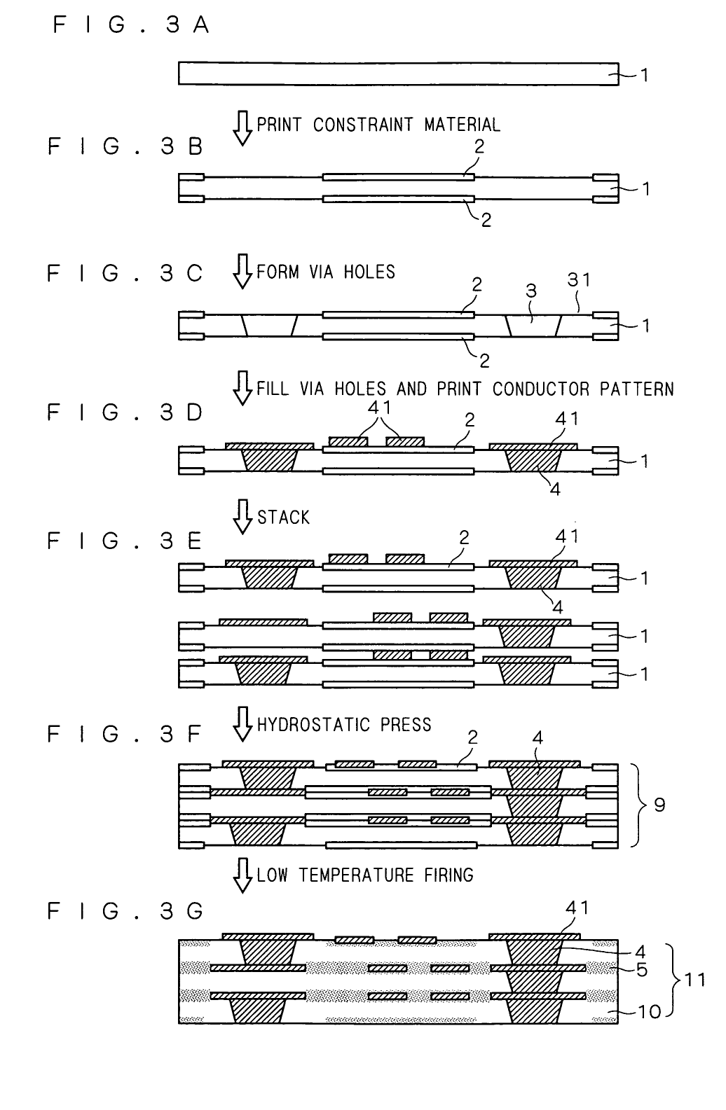

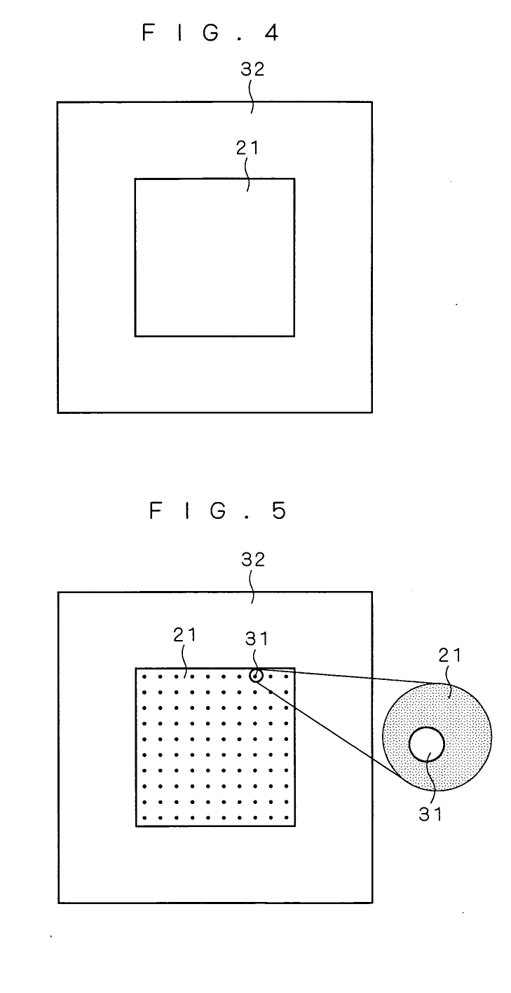

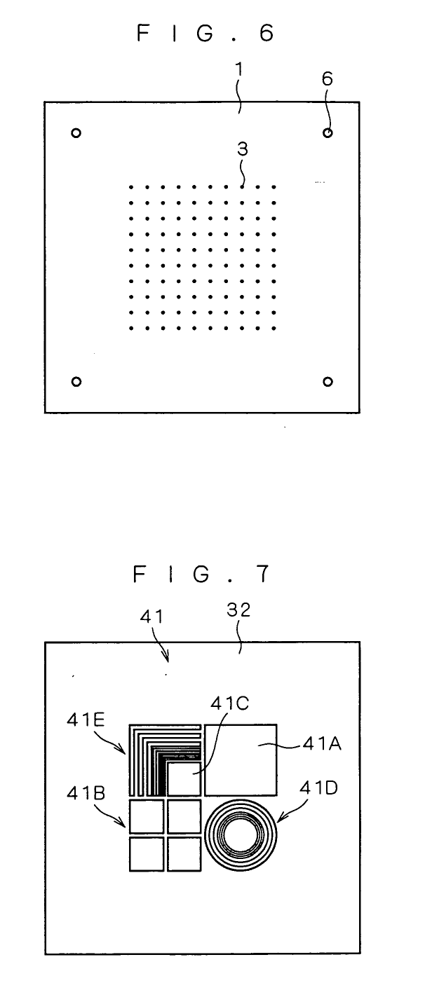

The method for manufacturing a multilayer substrate according to the preferred embodiment of the invention is now described referring to FIGS. 3A-3G to FIG. 10.

FIGS. 3A to 3G are cross-sectional views illustrating the process steps for manufacturing the multilayer substrate of this preferred embodiment. The process steps are described mainly referring to FIGS. 3A to 3G in conjunction with FIGS. 4 to 10.

<A-1. Process for Preparing Green Sheets>

First, a plurality of LTCC green sheets 1, as shown in FIG. 3A, are prepared. The LTCC green sheets 1 are manufactured as explained below.

The base material is prepared by mixing equal weights of an SiO₂—ZrO₂—Al₂O₃—B₂O₃—RO (where R═Ba, Ca, Mg) glass powder having a mean particle size of about 2 μm and an alumina powder having a mean particle size of about 2 μm, with the addition of organic binder, e.g. polyvinyl butyral resin or acrylic resin, and with plasticizer and dispersant, which is mixed and dispersed in a mixed organic solvent, e.g. of toluene and ethanol, so as to obtain a slurry. Next, from this slurry, a plurality of green sheets 1 (first green sheets) having a thickness of about 100 μm are obtained by a doctor blade process. Each green sheet 1 is cut to dimensions of 100 mm×100 mm.

Note that R═Ba, Ca, Mg means that at least one of Ba, Ca and Mg is used.

The doctor blade process is a method for forming slurry by passing it through gaps of a metal blade called a doctor blade. The green sheets thus obtained have plasticity and are soft.

While each green sheet 1 is subjected to subsequent conductor pattern formation process and via contact filling process, a silver paste is used as the co-firable conductor paste. The silver paste is prepared, for example, by preparing as the base material a silver powder having a mean particle size of 10 μm or less, adding approximately 3% by weight of the above-mentioned glass powder for the green sheets 1, with ethyl cellulose as organic binder, and with the addition of solvent, plasticizer and dispersant, and then sufficiently mixing and kneading it, e.g. with a roller kneader.

<A-2. Process of Printing Constraint Material>

Next, in the process step of FIG. 3B, a predetermined pattern of thick film of a material that is sintering-resistant at 1000° C. or lower (referred to as constraint material) is screen printed on both sides of the LTCC green sheet 1 to form constraint layers 2.

Two patterns of constraint layers 2 were prepared.

That is, as shown in FIG. 4, one of the patterns has a 50 mm×50 mm rectangular constraint layer print region 21 located in the center of the sheet, where a non-print region 32 surrounds the rectangular constraint layer print region 21.

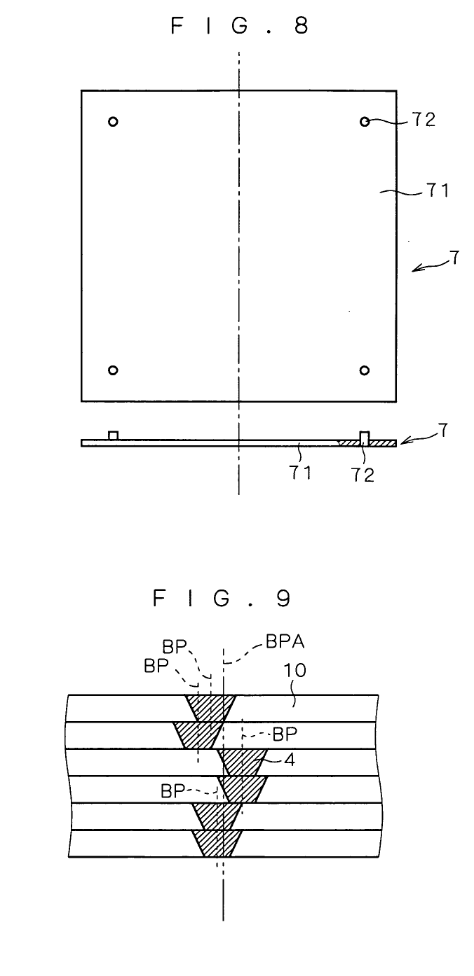

The other pattern is as shown in FIG. 5, where, in the 50 mm×50 mm rectangular constraint layer print region 21 in the center of the sheet, the portions of the constraint layer 2 that correspond to regions where via contacts are to be formed are removed in circular shape having a diameter of about 250 μm. Thus, in the rectangular constraint layer print region 21, a plurality of circular non-print regions 31 are disposed at equal intervals in a matrix. FIG. 5 also shows an enlarged view of a non-print region 31. Note that FIG. 3B shows a part of the LTCC green sheet 1, showing the circular non-print regions 31 and the surrounding constraint layer 2 in the pattern of FIG. 5.

The thickness of an actually printed constraint layer 2 was measured at a plurality of positions and values from 5 μm to 15 μm were obtained, where the mean value was about 10 μm. Hereinafter, a pattern formed as shown in FIG. 4 and having a mean thickness of about 10 μm is called pattern α and a pattern formed as shown in FIG. 5 and having a mean thickness of about 10 μm is called pattern β.

Also, for comparison, a pattern formed as shown in FIG. 4 and having a mean thickness of about 20 μm and a pattern formed as shown in FIG. 5 and having a mean thickness of about 20 μm were prepared, which are called pattern α′ and pattern β′, respectively.

The constraint material paste for the constraint layers 2 was prepared using a fused silica powder having a mean particle size of about 2 μm as the base material, with the addition of ethyl cellulose as organic binder, and with plasticizer and dispersant, which was processed similarly to the silver paste.

<A-3. Formation of Via Holes>

Next, in the process step shown in FIG. 3C, via holes 3, e.g. for interlayer interconnection, are formed in each LTCC green sheet 1.

FIG. 6 shows an arrangement pattern of the via holes 3. A plurality of via holes 3 are disposed in a matrix in a 50 mm×50 mm rectangular region in the center of the LTCC green sheet 1. Their diameter is about 150 μm. Each of the center of the plurality of circular non-print regions 31 (having a diameter of about 250 μm) described referring to FIG. 5 is aligned with the center of the via holes 3, so that the constraint layer 2 is absent around the via holes 3.

When the pattern α shown in FIG. 4 is adopted as the constraint layer 2, the constraint layer 2 is present in the positions where the via holes 3 are formed, in which case the via holes 3 are formed to pass through both the green sheet 1 and the constraint layers 2. In this case, the constraint layer 2 is present around the via holes 3.

The LTCC green sheet 1 has guide holes 6 having a diameter of about 3.0 mm and located in the four corners. The guide holes 6 are used to stack LTCC green sheets 1 in a later process.

<A-4. Filling of the Via Holes and Formation of Conductor Pattern>

Next, in the process step shown in FIG. 3D, the contact holes 3 in each LTCC green sheet 1 are filled with a conductor paste by screen printing to form via contacts 4. The conductor paste used in this step is the co-firable silver paste described earlier.

Subsequently, using the same silver paste, a conductor pattern 41 is formed by screen printing on the upper main surface of each green sheet 1.

FIG. 7 shows an example of the conductor pattern 41.

The conductor pattern 41 of FIG. 7 includes a plurality of pads 41A, 41B and 41C shown as variously sized rectangles, a plurality of dummy transmission lines 41D concentrically disposed at given intervals, and a plurality of similarly L-shaped dummy transmission lines 41E disposed at given intervals with their sides being aligned. The area outside the patterns 41A to 41E corresponds to the non-print region 32.

The thickness of an actually printed conductor pattern 41 was measured in a plurality of positions and the mean value was about 15 μm, which was nearly equal to that of the constraint layer 2.

While, as shown in FIG. 3D, the conductor pattern 41 is formed in the area where the constraint layer 2 is present, other green sheets were prepared for comparison which just have contact holes 3 filled with the silver paste and the conductor pattern 41, with no constraint layer.

<A-5. Process of Stacking the Green Sheets>

The plurality of LTCC green sheets 1 prepared as described above are dried and then stacked in the process step shown in FIG. 3E to form a green sheet stack.

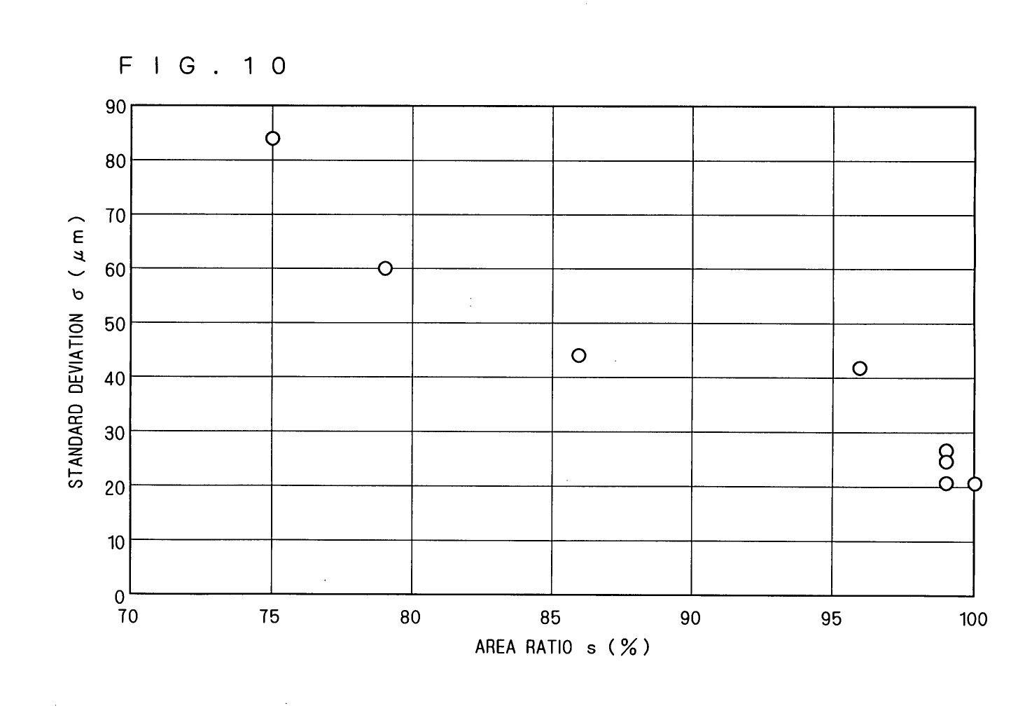

A jig 7 as shown in FIG. 8 is used in the layer stacking process. FIG. 8 shows a plan view and a side view of the layer-stacking jig 7.

As shown in FIG. 8, the layer-stacking jig 7 has a flat rectangular plate 71 and positioning pins 72 projecting in the four corners of the upper main surface of the plate 71 (the surface on which the green sheets are mounted).

As shown in the side view of FIG. 8 (which is shown as a partially cross-sectional view), the positioning pins 72 are disposed with their ends on one side inserted in the plate 71 and with the other ends vertically projecting from the main surface. The green sheets 1 are positioned and stacked so that the positioning pins 72 are inserted in the guide holes 6 located in the four corners of the LTCC green sheets 1. FIG. 3E does not show the layer-stacking jig 7.

<A-6. Process of Pressing the Green Sheets>

Next, in the process step shown in FIG. 3F, the stacked body of green sheets 1 mounted on the layer-stacking jig 7 (not shown) is vacuum-packed in a commercially available laminate bag (not shown).

Next, using a hydrostatic press, it is held in hot water of 80° C. for 30 minutes with a hydrostatic pressure of 30 MPa (megapascals), whereby the stacked layers are integrated by adhesion of the organic binder to obtain a green body 9. The green body 9 is then detached from the layer-stacking jig 7. Plural kinds of green bodies 9 were prepared, some having constraint layers 2 of one of the above-described four patterns, i.e. pattern α, β, α′, or β′, some having a combination of patterns, and some having no constraint layer 2.

<A-7. Process of Firing the Green Body>

Finally, in the process step shown in FIG. 3G, the green body 9 is fired at low temperature to obtain a fired body 11, i.e. a low-temperature co-firable ceramic multilayer substrate. This firing process adopts a temperature pattern including a binder removal process of holding it for 10 hours at about 500° C., a subsequent sintering process of holding it for 1 hour with the temperature elevated to 900° C., and a process of cooling it to room temperature in the furnace.

The plural kinds of green bodies 9 mentioned above were all fired using this temperature pattern.

By this firing, the LTCC green sheets 1 forming the green body 9 are sintered to form fired layers 10, with the patterns of constraint layers 2 restricting firing shrinkage in the stacking planes, and the glass contained in the green sheets 1 penetrates into the portions of the constraint layers 2 to bond the individual layers: the fired body 11 is thus obtained. FIG. 3G schematically shows the constraint layers 2 as bonding portions 5.

<B. Evaluation>

Table 1 below shows the structures of samples and comparative examples formed by the process steps above.

TABLE 1

| | | | Comparative | Comparative | Comparative | Comparative | Comparative |
|---|---|---|---|---|---|---|---|
| | Sample 1 | Sample 2 | Example 1 | Example 2 | Example 3 | Example 4 | Example 5 |
| First layer | Lower surface α | Lower surface α | No constraint | Lower surface α′ | No constraint | Lower surface α′ | Lower surface α |
| Second layer | Both surfaces β | Upper surface α | No constraint | No constraint | No constraint | Lower surface α′ | Both surfaces α |
| Third layer | Both surfaces β | No constraint | Lower surface α | Lower surface α′ | No constraint | Lower surface α′ | Both surfaces α |
| Fourth layer | Both surfaces α | No constraint | Upper surface α | No constraint | No constraint | Lower surface α′ | Both surfaces α |
| Fifth layer | Both surfaces β | No constraint | No constraint | Lower surface α′ | No constraint | Lower Surface α′ | Both surfaces α |
| Sixth layer | Both surfaces β | Lower surface α | No constraint | No constraint | No constraint | Lower surface α′ | Both surfaces α |
| Seventh layer | Upper surface α | Upper surface α | — | — | No constraint | No constraint | Upper surface α |

In Table 1, samples having the features of the invention are shown as Samples 1 and 2 and samples formed for comparison with the invention are shown as Comparative Examples 1, 2, 3, 4 and 5. Comparative Examples 4 and 5 in Table 1 correspond to the structures disclosed in Second and Third Patent Documents.

Comparative Examples 1 and 2 are six-layer structures in which six layers of green sheets 1 are stacked and the other samples are seven-layer structures. In Table 1, “first layer” means the uppermost layer of the green body 9, and second layer, third layer, and so on, are sequentially stacked down to the lowermost layer. Therefore, in Comparative Example 1, the sixth layer is the lowermost layer.

Also, in Table 1, “upper surface α (or β, or α′, or β′)” means that a constraint layer 2 having the pattern α (β, α′, β′) is formed on the upper surface of the green sheet 1. Similarly, “both surfaces α (or β, or α′, or β′)” means that constraint layers 2 having the pattern α (β, α′, β′) are formed on both surfaces of the green sheet 1, and “lower surface α (or β, or α′, or β′)” means that a constraint layer 2 having the pattern α (β, α′, β′) is formed on the lower surface of the green sheet 1.

Also, in Table 1, “no constraint” means that no constraint layer 2 is formed on the green sheet 1.

Observation of the surfaces of the samples and comparative examples in Table 1 showed that via contacts projected about 10 μm in Comparative Examples 4 and 5. In Comparative Examples 2 and 4, the rectangular conductor pattern shown in FIG. 7 convexly warped. No such phenomena were observed in the other samples and comparative examples.

Next, observation of cross-sections of the samples and comparative examples was made and the position of each via contact in each fired layer 10 was measured. FIG. 9 shows an example of a stack of via contacts 4 in an observed section.

As shown in FIG. 9, when the individual via contacts 4 are regarded as portions, they are layers stacked on top of each other, where some via contacts do not have their center axes shifted and others have their center axes shifted. Overall, the axis is shifted. The position of the center axis of each via contact 4 was measured and recorded as via position BP. A mean value of via positions BP thus obtained was calculated to obtain mean via position BPA.

Deviations (σi) were calculated on the basis of the via positions BP and the mean via position BPA to estimate the frequency of occurrence of via disconnection.

The via position deviation (σi) was defined as the distance from the mean via position BPA of the vertically stacked via contacts 4 to each via position BP.

In actual evaluation, about 100 via contacts 4 were observed and the standard deviation (σ) of via positions was obtained according to the following formula:
σ={1/n(σ₁²+σ₂²+σ₃² . . . +σₙ₋₁²+σₙ²)}^{1/2}

Table 2 shows the area ratio (s) obtained by dividing the area of the ceramic multilayer substrate 11 after sintered by the area of the green body, the standard deviation (σ) measured by the observation of cross-sections of the samples and comparative examples, and observed phenomena as notes.

TABLE 2

| | | | Comparative | Comparative | Comparative | Comparative | Comparative | |
|---|---|---|---|---|---|---|---|---|
| | Sample 1 | Sample 2 | Example 1 | Example 2 | Example 3 | Example 4 | Example 5 | Green Body |
| s (%) | 99 | 86 | 79 | 96 | 75 | 99 | 99 | 100 |
| σ (μm) | 27 | 44 | 60 | 42 | 84 | 21 | 25 | 21 |
| Notes | No via | No via | No via | No via projection | No via projection | Via projection | Via projection | — |
| | projection | projection | projection | Warp observed | No warp | observed | observed | — |
| | No warp | No warp | No warp | No via | Via disconnection | Warp | No warp | No via |
| | No via | No Via | Via | disconnection | observed | observed | No via | disconnection |
| | disconnection | disconnection | disconnection | | | no via | disconnection | |
| | | | observed | | | disconnection | | |

Table 2 also shows data about a green body 9 not fired, in addition to Samples 1 and 2 and Comparative Examples 1 to 5 shown in Table 1. The green body 9 is not fired and therefore not shrunk, so its area ratio (s) is 100% and it has no via disconnection.

In Table 2, Comparative Example 1 has an area ratio (s) of about 79% and a standard deviation (σ) of about 60 μm, and Comparative Example 3 has an area ratio (s) of about 75% and a standard deviation (σ) of about 80 μm. In these Examples, some via interconnections observed were vertically disconnected.

However, in the samples and comparative examples other than Comparative Examples 1 and 3, the standard deviations (σ) were all below 50 μm and no via disconnection was observed.

FIG. 10 is a graph showing the values of the standard deviation (σ) with respect to the area ratio (s) in Table 2.

In FIG. 10, the horizontal axis shows the area ratio (s) and the vertical axis shows the standard deviation (σ). It is seen from FIG. 10 that the standard deviation (σ) correlates with the area ratio (s) with a negative correlational coefficient.

Although how the via position deviations (σi) are distributed is unknown, we concluded, from the results thus obtained and common statistical formulas assuming Gaussian distribution, that via disconnection due to firing shrinkage hardly occurs when three times the standard deviation (σ) is equal to or less than the diameter of via contact 4.

As stated before, the via contacts 4 used herein have a diameter of about 150 μm. Also, considering the characteristic shown in FIG. 10 and the above-mentioned condition of the standard deviation (σ) that does not cause via disconnection, it is concluded that via disconnection will not occur when the area ratio (s) is 85% or more.

This is clear also from the fact that, in Table 2, no via disconnection occurred in Sample 1 and Comparative Examples 4 and 5 having area ratios (s) of about 99% or more.

However, via contacts projected in Comparative Examples 4 and 5. On the other hand, Sample 1 exhibited no projection of via contacts. It is thought that the firing shrinkage behaviors of the via contacts and the surrounding green sheets were nearly matched by combining the flat pattern α and the pattern β, in which via contact areas and the surrounding areas are non-printed, instead of using green sheets all having the same constraint layer pattern.

Sample 2, which has an area ratio (s) of 86%, has seven layers of 100-μm-thick green sheets 1 and four constraint layers 2 with a mean thickness of 10 μm. From the ratio of the total thickness of the constraint layers 2 with respect to the thickness of the green body, the thickness ratio providing necessary and sufficient firing shrinkage is obtained as 4/70. When this is applied to green sheets having a thickness of 300 μm, it is seen that necessary and sufficient firing shrinkage is obtained by forming constraint layers having a thickness of about 17 μm.

It is also seen from Table 2 that, with area ratios (s) of about 96% or less, no special measure is required to prevent via contact projection. That is to say, Sample 2 and Comparative Examples 2 and 3 have no constraint layers or have only one pattern of constraint layers and via contacts did not project even though no measure was taken.

However, the rectangular conductor pattern convexly warped in the structures having constraint layers only on one-side surfaces of green sheets, i.e. both in Comparative Examples 2 and 4, which shows that this problem cannot be solved just by restricting the firing shrinkage. On the other hand, Sample 1 and Comparative Example 5 having constraint layers on both surfaces of green sheets exhibited no warping of conductor patterns, which shows that providing constraint layers on both surfaces of green sheets prevents warping of the conductor patterns.

These results show that Sample 1 and Sample 2 have offered excellent results all about the area ratio (s), the via position standard deviation (σ), the via contact projecting, the conductor pattern warping, and the via connections.

Also, multilayer substrates having the combination of constraint layers of Sample 1 but having no via contacts and multilayer substrates having no constraint layers, like Comparative Example 3, and having no via contacts were made, and their deflection strength was evaluated with test pieces. This evaluation showed no particular strength reduction due to the presence/absence of constraint layers.

Also, no strength reduction of test pieces was observed with constraint layers having a mean thickness of 20 μm. However, with constraint layers printed twice to form a mean thickness of 30 μm, the stacked layers peeled during processing of the test pieces. This means that peeling may occur at stacking surfaces of multilayer substrates when the constraint layers 2 are thick films of 30 μm or thicker, but bonding strength sufficient for practical use is provided by penetration of glass from the green sheets when the constraint layers 2 have a thickness of 10 μm to 30 μm, more preferably 10 μm to 20 μm.

<C. Conclusion and Effects>

It has thus been found, from the test results of Sample 1, that using, in combination, the pattern β, in which the via contacts 4 and the surrounding areas are non-printed, i.e. the constraint layers 2 are absent around the via contacts, makes it possible to nearly match the firing shrinkage behaviors of the via contacts and the surrounding areas of the green sheets, thereby preventing projection of via contacts.

It has also been found, from the test results of Sample 2, that providing no constraint layers 2 on some of the green sheets 1 of the green body, e.g. providing constraint layers 2 on the uppermost and lowermost layers of the green body 9 and on the green sheet layers facing these layers and providing no constraint layers 2 on the remaining green sheets 1, reduces the plane shrinkage restricting effect and prevents projection of via contacts.

In this preferred embodiment, the diameter of the via contact 4 is about 150 μm and the diameter of the non-print region 31 in the pattern β (FIG. 5) is about 250 μm. It can thus be said that the projection of via contacts can be prevented by forming the non-print regions 31 in the constraint layers 2 so that their diameter is 1.7 times larger than the diameter of the via contact 4. In practice, the projection of via contacts can be prevented by setting the diameter of the non-print region 31 in the range of about 1.5 times to 2 times that of the via contact 4.

Also, while the non-print regions 31 are shaped in circular shape in the description above, their shape is not limited to circular shape. They can be formed in any shape as long as constraint layer 2 is absent around the via contacts.

For example, when via contacts are disposed densely, non-print regions 31 may overlap one another and not form circles, but it is still possible to prevent projection of via contacts. Also, in areas where via contacts exist densely, the non-print region may be sized and shaped to contain all of the densely disposed via contacts, instead of being shaped in circular shape.

Also, it has been found that when the green sheet 1 has a thickness of 100 μm to 300 μm, sufficient bonding strength and sufficient plane shrinkage restricting effect can be obtained by setting the thickness of pre-fired constraint layer 2 in the range of 10 μm to 20 μm.

Also, it was possible to restrict the plane shrinkage of green sheets by using fused silica powder having a mean particle size of about 2 μm as the base material of the constraint layers 2.

<D. First Modification>

The first preferred embodiment above has shown an example in which the constraint material paste for forming the constraint layers 2 uses fused silica powder as the base material. However, the constraint material can be a fused silica-glass paste that contains a mixture of 90% by volume of fused silica and 10% by volume of the SiO₂—ZrO₂—Al₂O₃—B₂O₃—RO (where R═Ba, Ca, Mg) glass powder having a mean particle size of about 2 μm which is used to form the green sheets 1.

That is to say, adding, to the constraint material paste, the glass material that softens at the firing temperature of the green sheets 1 weakens the plane shrinkage restricting effect and this method, too, is thus capable of controlling the plane shrinkage restricting effect.

More specifically, by using this fused silica-glass paste as the constraint material, a substrate having the same structure as Sample 1 shown in Table 1 provided an area ratio (s) of about 90%, meaning that the plane shrinkage restricting effect by the constraint material was reduced.

It is possible to reduce the plane shrinkage restricting effect as long as the fused silica is about 70% or more by volume and the glass powder is about 30% or less.

<E. Second Modification>

The first preferred embodiment above has shown an example in which the constraint material paste for forming the constraint layers 2 uses fused silica powder as the base material. However, the green sheet plane shrinkage restricting effect can be obtained by using, instead of fused silica powder paste, alumina paste that contains alumina powder having a mean particle size of about 2 μm as the base material.

That is to say, the plane shrinkage restricting effect can be obtained as long as the main component of the constraint material is sintering-resistant at the firing temperature of the green sheets, and alumina powder having a mean particle size of about 2 μm meets this condition.

When the multilayer substrate obtained by the preferred embodiment of the invention is used for high-frequency circuit, microwave circuit and millimeter wave circuit applications, using constraint material mainly containing fused silica or alumina having small dielectric loss tangent offers the effect to suppress power dissipation of the substrate, as well as the plane shrinkage restricting effect.

While the invention has been described in detail, the foregoing description is in all aspects illustrative and not restrictive. It is understood that numerous other modifications and variations can be devised without departing from the scope of the invention.

1. A multilayer substrate manufacturing method comprising the steps of:
(a) preparing a plurality of green sheets; and
(b) stacking and integrating said green sheets to form a green body, said step (a) comprising the steps of:
(a-1) printing, on said green sheet, constraint layers for restricting firing shrinkage which has a predetermined pattern;
(a-2) forming via holes in said green sheet on which said constraint layers are formed; and
(a-3) forming predetermined circuit patterns on said green sheets with a conductor paste and filling said via holes with said conductor paste to form via contacts, and
said step (a-1) comprising the steps of:
forming said predetermined pattern in areas where said via holes are to be formed in said green sheets so that non-print regions exist around said via holes; and
forming said constraint layers on both main surfaces of said green sheet except those placed as uppermost and lowermost layers of said green body.

2. The multilayer substrate manufacturing method according to claim 1, wherein said step (a-1) comprises the step of forming said non-print regions in a circular shape having a diameter that is 1.5 times to 2 times larger than the diameter of said via holes.

3. The multilayer substrate manufacturing method according to claim 1,
wherein said step (a) comprises the step of preparing said green sheets so that said green sheets have a firing temperature of 1000° C. or less and a thickness of not less than 100 μm nor more than 300 μm, respectively, and
said step (a-1) comprises the step of forming said constraint layers by choosing a material that is sintering-resistant at 1000° C. or less and said constraint layers have a thickness of not less than 10 μm nor more than 20 μm, respectively.

4. The multilayer substrate manufacturing method according to claim 1, wherein said step (a-1) comprises the step of choosing a fused silica powder having a mean particle size of 2 μm as a base material of said constraint layers.

5. The multilayer substrate manufacturing method according to claim 1, wherein said step (a-1) comprises the step of choosing an alumina powder having a mean particle size of 2 μm as a base material of said constraint layers.

6. The multilayer substrate manufacturing method according to claim 1, wherein said step (a-1) comprises the step of choosing, as a base material of said constraint layers, a fused silica-glass that contains a mixture of 90% by volume of a fused silica powder having a mean particle size of 2 μm and 10% by volume of an SiO₂—ZrO₂—Al₂O₃—B₂O₃—RO (where R═Ba, Ca, Mg) glass powder having a mean particle size of 2 μm.

7. A multilayer substrate manufacturing method, comprising the steps of:
(a) preparing a plurality of green sheets; and
(b) stacking and integrating said green sheets to form a green body;
said step (a) comprising the steps of:
(a-1) printing constraint layers for restricting firing shrinkage on, at least, said green sheets that are located in uppermost and lowermost layers of said green body;
(a-2) forming via holes in said green sheets on which said constraint layers are formed; and
(a-3) forming given circuit patterns on said green sheets with a conductor paste and filling said via holes with said conductor paste to form via contacts,
said step (a-1) comprising the step of preparing said green sheets so that one or more of said green sheets, except said green sheets located in the uppermost and lowermost layers of said green body, have no said constraint layer, and
said step (b) comprising the step of stacking said green sheet or sheets having no said constraint layer in a middle of said green body.

8. The multilayer substrate manufacturing method according to claim 7,
wherein said step (a) comprises the step of preparing said green sheets so that said green sheets have a firing temperature of 1000° C. or less and a thickness of not less than 100 μm nor more than 300 μm, respectively, and
said step (a-1) comprises the step of forming said constraint layers by choosing a material that is sintering-resistant at 1000° C. or lower and said constraint layers have a thickness of not less than 10 μm nor more than 20 μm, respectively.

9. The multilayer substrate manufacturing method according to claim 7, wherein said step (a-1) comprises the step of choosing a fused silica powder having a mean particle size of 2 μm as a base material of said constraint layers.

10. The multilayer substrate manufacturing method according to claim 7, wherein said step (a-1) comprises the step of choosing an alumina powder having a mean particle size of 2 μm as a base material of said constraint layers.

11. The multilayer substrate manufacturing method according to claim 7, wherein said step (a-1) comprises the step of choosing, as a base material of said constraint layers, a fused silica-glass that contains a mixture of 90% by volume of a fused silica powder having a mean particle size of 2 μm and 10% by volume of an SiO₂—ZrO₂—Al₂O₃—B₂O₃—RO (where R═Ba, Ca, Mg) glass powder having a mean particle size of 2 μm.
